(19) United States
(12) Patent Application Publication
(10) Pub. No.: US 2012/0304699 A1
(43) Pub. Date: Dec. 6, 2012

(54) PROCESS FOR COARSE DECARBURIZATION OF A SILICON MELT

(76) Inventor: Jochen Hintermayer, Trostberg (DE)

(21) Appl. No.: 13/574,322

(22) PCT Filed: Dec. 27, 2010
(86) PCT No.: PCT/EP2010/070753

§ 371 Date: Jul. 20, 2012

(30) Foreign Application Priority Data
Jan. 21, 2010 (DE) 102010001093.6

(51) Int. Cl. C01B 33/037

(52) U.S. Cl. 65/134.4

(57) ABSTRACT

The present invention relates to a novel process for coarse decarburization of a silicon melt, and to the use thereof for production of silicon, preferably solar silicon or semiconductor silicon.

The present invention relates to a novel process for coarse decarburization of a silicon melt, and to the use thereof for production of silicon, preferably solar silicon or semiconductor silicon.

There are various known processes in which the carbon content of a silicon melt is lowered in a plurality of steps. One example is the Solsilc process (www.ecn.nl), in which a decarburization is carried out in a plurality of steps. This involves first cooling the tapped-off silicon under controlled conditions, in the course of which SiC particles separate out of the melt. These are then removed from the silicon in ceramic filters. Subsequently, the silicon is deoxidized with an argon-water vapour mixture. Finally, the prepurified, coarsely decarburized silicon is supplied to a directed solidification. However, the process described is costly and inconvenient since SiC particles separating out in the course of controlled cooling stick to the crucible wall. Moreover, the ceramic filters are frequently blocked by SiC particles. After the filtering has ended, crucible and filter additionally have to be cleaned in laborious operations, for example by acid cleaning with hydrofluoric acid.

In alternative approaches, for example, DE 3883518 and JP2856839 have proposed blowing SiO₂ into a silicon melt. The SiO₂ reacts with the carbon dissolved in the silicon melt to form CO. This in turn escapes from the silicon melt.

A disadvantage of this process is that the SiC present in the silicon melt does not react completely with the SiO₂. Various modifications to this process have therefore been developed and are described in JP02267110, JP6345416, JP4231316, DE 3403131 and JP2009120460. Disadvantages of these processes which have become known include caking on and blockages of plant parts.

There is therefore still an urgent need for an effective, simple and inexpensive process for decarburization of a silicon melt, obtained by carbothermic reduction of SiO₂.

It was therefore an object of the present invention to provide a novel process for decarburization of a silicon melt, which has the disadvantages of the prior art processes only to a reduced degree, if at all. In a specific object, the process according to the invention shall be employable for production of solar silicon and/or semiconductor silicon. It was a further specific object to provide a process which enables the total carbon content of the silicon melt to be reduced before the reduction furnace is tapped to such an extent that there is substantially no, if any, SiC deposition in the course of cooling of the material which has been tapped off to below 1500° C. Further objects not specified explicitly are evident from the overall context of the description, examples and claims which follow.

The objects are achieved by the process described in detail in the description which follows, the examples and the claims.

The inventors have found that, surprisingly, it is possible in a simple, inexpensive and effective manner to achieve coarse decarburization of a silicon melt when an oxygen carrier is introduced into the silicon melt, but the addition is interrupted once or more than once by a hold time.

This process is advantageous especially because the problems of the prior art processes, for example blockage of the filters or complex purification of filters, can be dispensed with and the level of cost and inconvenience can be reduced. In addition, the apparatus complexity is reduced.

A silicon melt which originates from a light arc reduction furnace has a carbon content of about 1000 ppm. At a tapping temperature of 1800° C., the majority of this carbon is dissolved in the melt. If, however, the melt is cooled, for example to 1600° C., the result is that a large portion of the carbon precipitates out of the oversaturated melt as SiC. The carbon solubility in silicon as a function of temperature is described, according to Yanaba et al., Solubility of Carbon in liquid Silicon, Materials Transactions.JIM, Vol. 38, No. 11 (1997), pages 990 to 994, by

log C=3.63−9660/T

where the carbon content C is reported in percent by mass, and the temperature T in degrees Kelvin. Table 1 below shows the relationship for a melt with 1000 ppm:

TABLE 1

| | C dissolved | C in form of |
|---|---|---|
| T [° C.] | [ppm] | SiC [ppm] |
| 1800 | 933 | 67 |
| 1700 | 542 | 458 |
| 1600 | 297 | 703 |
| 1500 | 152 | 848 |

SiC is much more difficult to remove from the silicon melt than dissolved carbon. The process according to the invention is therefore based on the idea of first lowering the carbon content of the silicon melt by coarse decarburization to such an extent that substantially no SiC, if any, is precipitated out of the melt after cooling to less than 1500° C.

This is achieved in accordance with the invention by performing the coarse decarburization of the silicon melt, preferably still within the reduction furnace, more preferably within a light arc reduction furnace, by adding an oxygen carrier to the silicon melt, the addition being interrupted once or more than once for a particular period (hold time).

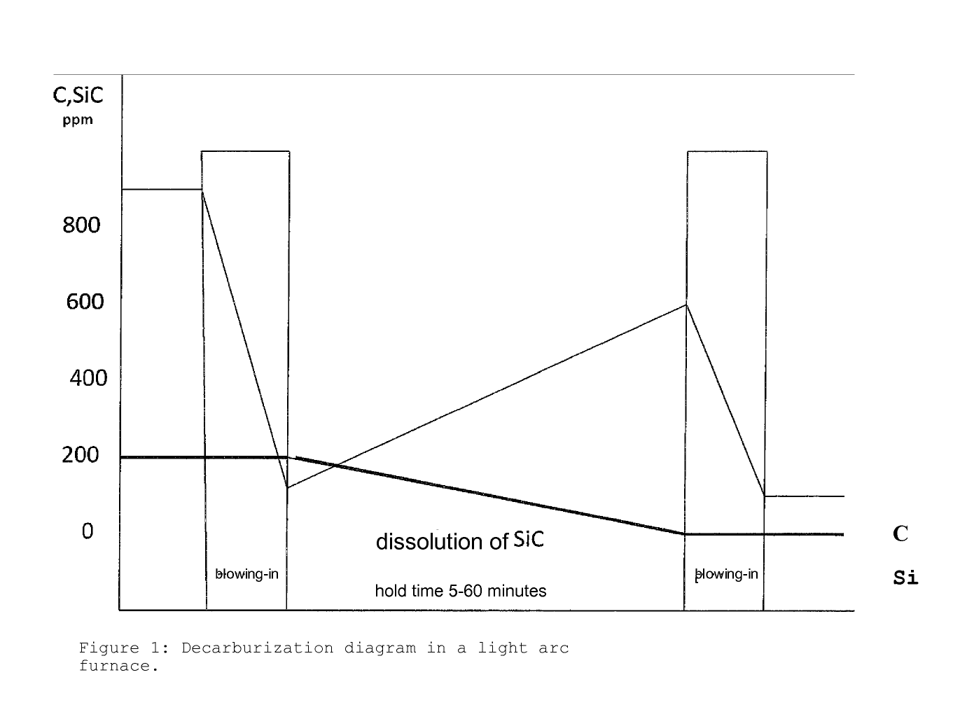

Without being bound to a particular theory, the inventors are of the view that, in the addition times of the oxygen carrier, the carbon dissolved in the silicon melt is removed from the melt to obtain a carbon-undersaturated melt. In the interruption times (hold times), SiC can dissolve again in the silicon melt. This again forms dissolved carbon from SiC, the former subsequently being removable readily from the melt by renewed addition of an oxygen carrier. The relationship mentioned is illustrated graphically once again in FIG. 1. In this simple manner, the total carbon content of the silicon melt, preferably before the tapping, can be lowered to less than 150 ppm, preferably less than 100 ppm. This makes it possible, without filtration and hence with avoidance of the problems known from the prior art, to obtain an SiC-free or substantially SiC-free melt, which can subsequently be subjected to a fine decarburization by known processes. Compared to prior art processes, such as the Solsilc process, the process according to the invention constitutes a significantly simpler, more effective and more favourable process with an improved space-time yield. Compared to the abovementioned processes known from the prior art, in which SiO₂ is added to the silicon melt, the process according to the invention has the advantage of a significantly better SiC removal from the melt. This can be explained by the fact that no hold times are envisaged in the prior art processes, and hence substantially only the dissolved C is removed from the melt therein.

The present invention thus provides a process for coarse decarburization of a silicon melt, characterized in that an oxygen carrier is added to a silicon melt, the addition of the oxygen carrier being interrupted once or more than once and then being continued once again.

In the context of the present invention, “coarse decarburization” means a reduction in the total carbon content of the silicon melt to less than 250 ppm, preferably less than 200 ppm, more preferably less than 150 ppm and especially preferably to 10 to 100 ppm.

In the context of the present invention, “fine decarburization” means a reduction in the total carbon content of the silicon melt to less than 5 ppm, preferably less than 3 ppm, more preferably less than 2 ppm and especially preferably to 0.0001 to 1 ppm.

“Substantially no SiC in the silicon melt” means that the proportion by weight of the SiC in the total carbon content of the silicon melt is less than 20% by weight, preferably less than 10% by weight, more preferably less than 5% by weight, most preferably less than 1% by weight.

The oxygen carrier may be an oxidizing agent or a gas, liquid or solid comprising an oxygen supplier. The oxygen carrier may in principle be added in any state of matter.

The oxygen carrier is preferably a chemical substance which does not introduce any additional impurities into the silicon melt. Particular preference is given, however, to using SiOₓ where x=0.5 to 2.5 and especially preferably silicon dioxide as a powder, more preferably with a mean particle size of less than 500 μm, and most preferably with a mean particle size of 1 to 200 μm, pellets, preferably with a mean particle size of 500 μm to 5 cm, even more preferably with a mean particle size of 500 μm to 1 cm and especially preferably with a mean particle size of 1 mm to 3 mm, or pieces. This silicon dioxide may originate from any source.

In a specific embodiment, silicon dioxide which is obtained from the reaction of the silicon monoxide formed as a by-product in the silicon production with air or another oxygen source is used. Particular preference is given to collecting the SiO by-product and, after conversion to SiO₂, introducing it directly back into the silicon melt, most preferably so as to give rise to a closed circuit.

In a preferred embodiment of the present invention, the solid silicon dioxide, preferably the silicon dioxide powder, is blown into the silicon melt by means of a gas stream, preferably of a noble or inert gas, more preferably of a noble gas, hydrogen, nitrogen or ammonia stream, more preferably an argon or nitrogen stream, or a stream composed of a mixture of the aforementioned gases.

The oxygen carrier can be added to the melt at different points. For instance, the oxygen carrier can be added to the silicon melt in the reduction reactor before it has been tapped off. However, it is also possible to tap off the silicon and then to add the oxygen carrier to the silicon melt, for example in a melting crucible or a melting tank. Combinations of these process variants are likewise conceivable. Particular preference is given to supplying the oxygen carrier to the silicon melt still within the reduction reactor.

The oxygen carrier can be supplied to the silicon melt in various ways. For instance, the oxygen carrier can be blown onto or into the silicon melt through a hollow electrode.

However, it is also possible to modify the reduction reactor in such a way that it comprises supply tubes (probes) through which the oxygen carrier can be blown into or onto the silicon melt. These supply tubes have to be configured from a material which does not melt at the temperatures which act on the tube. In the production of solar silicon, it is additionally necessary to prevent the silicon melt from being contaminated by contact with the tube. The tube is thus preferably produced from high-purity graphite, quartz, silicon carbide or silicon nitride.

The temperature of the melt on addition of the oxygen carrier should be between 1500° C. and 2000° C., preferably 1600° C. and 1900° C., more preferably between 1700° C. and 1800° C. According to the temperature, the C and SiC contents in the silicon melt vary as shown in Table 1.

In the process according to the invention, the addition of the oxygen carrier is interrupted once or more than once and then continued again. Preference is given to performing one to 5 interruptions each of 1 min to 5 h, preferably 1 min to 2.5 h, more preferably 5 to 60 minutes. Particular preference is given to interrupting the addition once for the aforementioned period. Very particular preference is given to first adding the oxygen carrier to the silicon melt and, after an addition time of 0.1 min to 1 hour, preferably 0.1 min to 30 min, more preferably 0.5 min to 15 min and especially preferably 1 min to 10 min, interrupting the addition for a duration (hold time) of 1 min to 5 h, preferably 1 min to 2.5 h, more preferably 5 to 60 minutes, in order to enable the dissolution of the SiC particles in the melt. After the end of the hold time, the addition of the oxygen carrier is restarted and continued until the desired low total carbon content, preferably less than 150 ppm, more preferably less than 100 ppm, has been attained. Over the entire process duration, the temperature of the melt is preferably held within the abovementioned range.

Preferably, in the process according to the invention, 1 to 5 times the stoichiometric amount of the oxygen carrier, preferably 2 to 3 times the stoichiometric amount, is added.

In batchwise processes, the oxygen carrier is added preferably at the end of the reaction of SiO₂ and C, but more preferably before the tapping of the reduction furnace. In continuous processes, the addition preferably follows each tapping, i.e. the silicon melt is tapped off and collected in a suitable apparatus, for example a melting crucible or a melting tank, and then subjected to a coarse decarburization by the process according to the invention.

In a specifically preferred embodiment, pulverulent silicon dioxide as an oxygen carrier is blown into the melt with a probe, preferably made of graphite. The probe is preferably fed in through a hollow electrode with zero current flow beforehand, or introduced into the furnace at the side by means of a ceramic guide element. In another especially preferred embodiment, the silicon dioxide is blown onto the silicon melt directly through the hollow electrode with a gas stream, preferably noble gas stream, more preferably an argon stream. In both cases, the silicon dioxide melts and reacts with the silicon melt, in the course of which the dissolved carbon is oxidized to CO and is therefore degraded according to

C+SiO₂═CO+SiO.

The carbon content falls according to the amount blown in. SiC particles which have separated out in the melt are not oxidized at first. These are dissolved in the silicon melt, which is undersaturated after the first addition of silicon dioxide, i.e. the first oxidative treatment, within a hold time of 5 to 60 minutes. After this hold time, the melt is once again treated oxidatively as described above, i.e. silicon dioxide is added. The carbon content of the melt can thus be lowered to about 100 ppm, and the melt is free or substantially free of SiC impurities.

The process according to the invention can additionally be made more effective by passing a bubble former through the/into the melt or adding it to the melt. The bubble former used may be a gas or a gas-releasing substance. The bubble former multiplies the number of gas bubbles and improves the driving of the COₓ gases out of the melt. The gas passed through the melt may, for example, be a noble gas or hydrogen or nitrogen, preferably argon or nitrogen.

The gas-releasing substance, preferably a solid, is preferably added to the oxygen carrier, more preferably in a proportion by weight of 1% to 10% based on the mixture of oxygen carrier and gas former. A suitable agent for this purpose is ammonium carbonate powder because it decomposes to gases without residue when blown into the melt, and does not contaminate the melt.

The silicon which has been coarsely decarburized by the process according to the invention can subsequently be subjected to a fine decarburization by processes known to those skilled in the art. This is particularly simple because only or substantially only dissolved carbon is present in the coarsely decarburized melt, and no or substantially no SiC.

Suitable processes for fine decarburization are known to those skilled in the art and include, for example, directed solidification, oxidative treatments of the melt, zone melting.

The process according to the invention can be used to produce metallurgical silicon, but also to produce solar silicon or semiconductor silicon. A prerequisite for production of solar silicon or semiconductor silicon is that the materials used, especially SiO₂ and C, and the apparatus/reactors used and the parts thereof which come into contact with the silicon/the silicon melt have appropriate purities.

Preferably, in the process for producing solar silicon and/or semiconductor silicon, the purified, pure or highly pure materials and raw materials used, such as silicon dioxide and carbon, feature a content of:
a. aluminium less than or equal to 5 ppm, preferably between 5 ppm and 0.0001 ppt, especially between 3 ppm and 0.0001 ppt, preferably between 0.8 ppm and 0.0001 ppt, more preferably between 0.6 ppm and 0.0001 ppt, even better between 0.1 ppm and 0.0001 ppt, even more preferably between 0.01 ppm and 0.0001 ppt, even more preference being given to 1 ppb to 0.0001 ppt,
b. boron less than 10 ppm to 0.0001 ppt, especially in the range from 5 ppm to 0.0001 ppt, preferably in the range from 3 ppm to 0.0001 ppt or more preferably in the range from 10 ppb to 0.0001 ppt, even more preferably in the range from 1 ppb to 0.0001 ppt,
c. calcium less than or equal to 2 ppm, preferably between 2 ppm and 0.0001 ppt, especially between 0.3 ppm and 0.0001 ppt, preferably between 0.01 ppm and 0.0001 ppt, more preferably between 1 ppb and 0.0001 ppt,
d. iron less than or equal to 20 ppm, preferably between 10 ppm and 0.0001 ppt, especially between 0.6 ppm and 0.0001 ppt, preferably between 0.05 ppm and 0.0001 ppt, more preferably between 0.01 ppm and 0.0001 ppt and most preferably 1 ppb to 0.0001 ppt;
e. nickel less than or equal to 10 ppm, preferably between 5 ppm and 0.0001 ppt, especially between 0.5 ppm and 0.0001 ppt, preferably between 0.1 ppm and 0.0001 ppt, more preferably between 0.01 ppm and 0.0001 ppt and most preferably between 1 ppb and 0.0001 ppt,
f. phosphorus less than 10 ppm to 0.0001 ppt, preferably between 5 ppm and 0.0001 ppt, especially less than 3 ppm to 0.0001 ppt, preferably between 10 ppb and 0.0001 ppt and most preferably between 1 ppb and 0.0001 ppt,
g. titanium less than or equal to 2 ppm, preferably less than or equal to 1 ppm to 0.0001 ppt, especially between 0.6 ppm and 0.0001 ppt, preferably between 0.1 ppm and 0.0001 ppt, more preferably between 0.01 ppm and 0.0001 ppt and most preferably between 1 ppb and 0.0001 ppt,
h. zinc less than or equal to 3 ppm, preferably less than or equal to 1 ppm to 0.0001 ppt, especially between 0.3 ppm and 0.0001 ppt, preferably between 0.1 ppm and 0.0001 ppt, more preferably between 0.01 ppm and 0.0001 ppt and most preferably between 1 ppb and 0.0001 ppt,
   and which more preferably have a sum of the above-mentioned impurities of less than 10 ppm, preferably less than 5 ppm, more preferably less than 4 ppm, even more preferably less than 3 ppm, especially preferably 0.5 to 3 ppm and very especially preferably 1 ppm to 3 ppm. For each element, a purity within the range of the detection limit may be the aim.

Solar silicon features a minimum silicon content of 99.999% by weight, and semiconductor silicon a minimum silicon content of 99.9999% by weight.

The process according to the invention can be incorporated as a component process into any metallurgical process for production of silicon, for example the process according to U.S. Pat. No. 4,247,528 or the Dow Corning process according to Dow Corning, “Solar Silicon via the Dow Corning Process”, Final Report, 1978; Technical Report of a NASA Sponsored project; NASA-CR 157418 or 15706; DOE/JPL-954559-78/5; ISSN: 0565-7059 or the process developed by Siemens, according to Aulich et al., “Solar-grade silicon prepared by carbothermic reduction of silica”; JPL Proceedings of the Flat-Plate Solar Array Project Workshop on Low-Cost Polysilicon for Terrestrial Photovoltaic Solar-Cell Applications, 02/1986, p 267-275 (see N86-26679 17-44). Likewise preferred is the incorporation of the process step into the processes according to DE 102008042502 or DE 102008042506.

### Test Methods

The determination of the abovementioned impurities is carried out by means of ICP-MS/OES (inductively coupled spectrometry—mass spectrometry/optical electron spectrometry) and AAS (atomic absorption spectroscopy).

The carbon content in the silicon or the silicon melt after cooling is determined by means of an LECO(CS 244 or CS 600) elemental analyser. This is done by weighing approx. 100 to 150 mg of silica into a ceramic crucible, providing it with combustion additives and heating under an oxygen stream in an induction oven. The sample material is covered with approx. 1 g of Lecocel II (powder of a tungsten-tin (10%) alloy) and about 0.7 g of iron filings. Subsequently, the crucible is closed with a lid. When the carbon content is in the low ppm range, the measurement accuracy is increased by increasing the starting weight of silicon to up to 500 mg. However, the starting weights of additives remain unchanged. The operating instructions for the elemental analyser and the instructions from the manufacturer of Lecocel II should be noted.

The mean particle size of the pulverulent oxygen carriers is determined by means of laser diffraction. The use of laser diffraction for determination of particle size distributions of pulverulent solids is based on the phenomenon that particles scatter or diffract the light from a monochromatic laser beam with differing intensity patterns in all directions according to their size. The smaller the diameter of the irradiated particle, the greater are the scattering or diffraction angles of the monochromatic laser beam.

The measurement procedure which follows is described with reference to silicon dioxide samples.

In the case of hydrophilic silicon dioxides, the sample is prepared and analysed with demineralized water as the dispersing liquid, and with pure ethanol in the case of silicon dioxides which are insufficiently wettable with water. Before the start of the analysis, the LS 230 laser diffractometer (from Beckman Coulter; measurement range: 0.04-2000 μm) and the liquid module (Small Volume Module Plus, 120 ml, from Beckman Coulter) is allowed to warm up for 2 h, and the module is rinsed three times with demineralized water. To analyse hydrophobic silicon dioxides, the rinsing operation is performed with pure ethanol.

In the instrument software of the LS 230 laser diffractometer, the following optical parameters which are relevant for an evaluation according to the Mie theory are stored in a .rfd file:

Refractive index of the dispersing liquid R.I. Real_{water}=1.332 (1.359 for ethanol)
Refractive index of the solid (sample material) Real_{silica}=1.46

### Imaginary=0.1

Form factor=1

In addition, the following parameters relevant for the particle analysis should be set:

Measurement time=60 s
Number of measurements=1
Pump speed=75%

Depending on the sample characteristics, the sample can be added to the liquid module (Small Volume Module Plus) of the instrument directly as a pulverulent solid with the aid of a spatula or in suspended form by means of a 2 ml disposable pipette. When the sample concentration required for the analysis has been attained (optimum optical shadowing), the instrument software of the LS 230 laser diffractometer gives an “OK” message.

Ground silicon dioxides are dispersed by 60 s of ultrasonication by means of a Vibra Cell VCX 130 ultrasound processor from Sonics with a CV 181 ultrasound converter and 6 mm ultrasound tip at 70% amplitude with simultaneous pumped circulation in the liquid module. In the case of unground silicon dioxides, the dispersion is effected without ultrasonication by 60 s of pumped circulation in the liquid module.

The measurement is effected at room temperature. The instrument software uses the raw data, on the basis of the Mie theory, with the aid of the optical parameters recorded beforehand (.rfd file), to calculate the volume distribution of the particle sizes and the d50 value (median).

ISO 13320 “Particle Size Analysis—Guide to Laser Diffraction Methods” describes the method of laser diffraction for determination of particle size distributions in detail. The person skilled in the art finds therein a list of the optical parameters which are relevant for an evaluation according to the Mie theory for alternative oxygen carriers and dispersing liquids.

In the case of granular oxygen carriers, the mean particle size is determined by means of screen residue analysis (Alpine).

This screen residue determination is an air jet screening process based on DIN ISO 8130-1 by means of an S 200 air jet screening instrument from Alpine. To determine the d₅₀ of microgranules and granules, screens having a mesh size of >300 μm are also used for this purpose. In order to determine the d₅₀, the screens must be selected such that they provide a particle size distribution from which the d₅₀ can be determined. The graphical representation and evaluation is effected analogously to ISO 2591-1, Chapter 8.2.

The d₅₀ is understood to mean the particle diameter in the cumulative particle size distribution at which 50% of the particles have a lower particle diameter than or the same particle diameter as the particles with the particle diameter of the d₅₀.

The examples which follow illustrate the process according to the invention without restricting it in any way.

### COMPARATIVE EXAMPLE 1

In a light arc furnace with an installed power of 1 MW, silicon was obtained from high-purity raw materials. Every 4 hours, approx. 215 kg of silicon were tapped off periodically. No decarburization was undertaken. A sample was taken from the casting jet and quenched. The carbon content was 1180 ppm. A grinding sample showed numerous inclusions of SiC under the scanning electron microscope (SEM).

### COMPARATIVE EXAMPLE 2

The experiment was carried out according to comparative example 1, except that SiO₂ pellets were blown into the melt 5 minutes before the tapping by means of a CFC probe which had been fed in through a hollow electrode. 1 m³ (STP) of argon laden with 750 g of SiO₂ (3 times the stoichiometric amount) was blown in per minute. The oxidative treatment lasted 5 minutes. This was immediately followed by tapping. The quenched sample had a carbon content of 125 ppm; the SEM sample showed isolated SiC inclusions.

### EXAMPLE 1

The experiment was carried out according to comparative example 1, except that 3 kg of SiO₂ pellets with 1 m³ (STP) of argon were blown onto the melt through the hollow electrode within 5 minutes 45 minutes before the planned tapping. This was followed by waiting for 35 minutes. Subsequently, SiO₂ powder was once again blown onto the melt for 5 minutes, which was followed immediately by tapping. The quenched sample showed a carbon content of 108 ppm; SiC inclusions were not found.

Example 1 shows very clearly the effectiveness and the advantages of the process according to the invention, even compared to prior art processes (comparative example 2). Especially the significant reduction in SiC inclusions is remarkable.

1. A process for coarse decarburization of a silicon melt, wherein an oxygen carrier is added to a silicon melt, the addition of the oxygen carrier being interrupted once or more than once by a hold time in each case, and the addition then being continued once again.

2. The process according to claim 1, wherein the oxygen carrier is added in solid form.

3. The process according to claim 2, wherein the oxygen carrier is blown into the silicon melt, onto the silicon melt, or any combination thereof by means of a gas stream.

4. The process according to claim 1, wherein the silicon melt on addition of the oxygen carrier has a temperature of 1500° C. to 2000° C.

5. The process according to claim 1, wherein the addition of the oxygen carrier is interrupted once or more than once, for a hold time of 1 minute to 5 hours.

6. The process according to claim 5, wherein the addition of the oxygen carrier is interrupted after an addition time of 0.1 minutes to 1 hour.

7. The process according to claim 1, wherein the addition of the oxygen carrier is continued until the total carbon content of the silicon melt is less than 250 ppm.

8. The process according to claim 1, wherein a bubble former is supplied to the silicon melt by introducing a gas.

9. A process for producing silicon by reduction of SiO₂ with carbon, wherein a coarse decarburization of the silicon melt is performed by a process according to claim 1.

10. The process according to claim 9, wherein the silicon is solar silicon or semiconductor silicon.

11. The process according to claim 9, wherein the coarse decarburization is followed by a fine decarburization such that the total carbon content of the silicon melt is lowered to less than 5 ppm.

12. The process according to claim 1, wherein the process is a batch process.

13. The process according to claim 1, wherein the process is a continuous process wherein the oxygen carrier is added to the silicon melt outside the of a reduction furnace after the silicon melt has been tapped off.

14. The process according to claim 1, wherein the oxygen carrier is silicon dioxide.

15. The process according to claim 3, wherein the gas stream is a noble gas stream.

16. The process according to claim 1, wherein the addition of the oxygen carrier is continued until the proportion by weight of the SiC in the total carbon content of the silicon melt is less than 20% by weight.

17. The process according to claim 8, wherein the gas is a noble gas.

18. The process according to claim 1, wherein a bubble former is introduced to the silicon melt by supplying a gas-forming substance.

19. The process according to claim 18, wherein the gas-forming substance is ammonium carbonate powder.

20. The process according to claim 9, wherein the carbon is high-purity carbon.

21. The process according to claim 9, wherein the silicon dioxide is high-purity silicon dioxide.

22. The process according to claim 1, wherein the oxygen carrier is added in a reduction furnace before the silicon melt has been tapped off.
